(19) United States
(12) Patent Application Publication
(10) Pub. No.: US 2016/0150352 A1
(43) Pub. Date: May 26, 2016

(54) BLUETOOTH SYSTEM INTEGRATION MODULE

(71) Applicants: HYUNDAI AMERICA TECHNICAL CENTER, INC., Superior Township, MI (US); HYUNDAI MOTOR COMPANY, Seoul (KR); KIA MOTORS CORPORATION, Seoul (KR)

(72) Inventors: Mustafa Saed, Bloomfield Hills, MI (US); Joseph Steffey, Brownstown Township, MI (US)

(21) Appl. No.: 14/559,133

(22) Filed: Dec. 3, 2014

Related U.S. Application Data
(63) Continuation-in-part of application No. 14/552,369, filed on Nov. 24, 2014, now abandoned.

(51) Int. Cl. H04W 4/00; H04B 1/3822; H04W 12/06

(52) U.S. Cl. CPC H04W 4/008; H04W 12/06; H04B 1/3822

(57) ABSTRACT

A method of integrating Bluetooth protocols in establishing a connection between a Bluetooth-enabled mobile device and a vehicle telematics system having two or more Bluetooth controllers includes establishing a Bluetooth communication channel between the mobile device and a first Bluetooth controller. The first Bluetooth controller authenticates the mobile device. In response to successful authentication of the mobile device, a secure connection between the first Bluetooth controller and a second Bluetooth controller is established. Authentication credentials of the authenticated mobile device are sent from the first Bluetooth controller to the second Bluetooth controller. Commands received from the mobile device via the Bluetooth communication channel are processed by the first Bluetooth controller or the second Bluetooth controller depending on the protocol utilized by the mobile device.

### BACKGROUND

1. Technical Field

The present disclosure relates to a system for connecting a wireless device carried by an individual to a vehicle network, and more particularly, a method of integrated authentication of different types of short range wireless communication systems.

2. Description of the Related Art

Although there are a number of widely-available standards for wirelessly transmitting audio between devices, some standards typically require the consumption of too much power for implementation in mobile devices. For example, many modem electronic devices use the Bluetooth Classic standard (“BTC”) for wirelessly transmitting audio. BTC is described in the Core v. 4.0 Specification for the Bluetooth System from the Bluetooth Special Interest Group (SIG) of Kirkland, Wash.

Bluetooth Low Energy (BLE) is another wireless communication technology published by the Bluetooth SIG as a component of Bluetooth Core Specification Version 4.0. BLE is a lower power, lower complexity, and lower cost wireless communication protocol, designed for applications requiring lower data rates and shorter duty cycles. Inheriting the protocol stack and star topology of BTC, BLE redefines the physical layer specification, and involves many new features such as a very-low power idle mode, a simple device discovery, and short data packets, etc.

However, BTC and BLE communication protocols are not compatible. Existing Bluetooth implementations typically require separate access channels to separate BTC and BLE systems. In cases of BTC and BLE technology being integrated in a vehicle, increasing a vehicle pairing and reconnection wait time is not always desirable and may often cause customer dissatisfaction.

### SUMMARY

An object of various embodiments of the present invention is to provide a method, computer program product and a wireless control module of a vehicle telematics system for integrating BTC and BLE protocols in establishing a connection between a Bluetooth-enabled mobile device and the vehicle telematics system having two or more Bluetooth controllers.

In order to achieve the above objects, a method for integrating BTC and BLE protocols according to an exemplary embodiment of the present invention may include establishing a Bluetooth communication channel between the mobile device and a first Bluetooth controller. The first Bluetooth controller may authenticate the mobile device. In response to successful authentication of the mobile device, a secure connection between the first Bluetooth controller and a second Bluetooth controller may be established. Authentication credentials of the authenticated mobile device may be sent from the first Bluetooth controller to the second Bluetooth controller. Commands received from the mobile device via the Bluetooth communication channel may be processed by the first Bluetooth controller or the second Bluetooth controller depending on the protocol utilized by the mobile device. In other words the first and second controllers advantageously cooperate to effect authentication process, and may comprise either both active controllers having authentication capability or an active and more passive controller, with the active controller (e.g., the first controller) controlling the authentication process.

Further, in order to achieve the above objects, a computer program product for integrating Bluetooth protocols in establishing a connection between a Bluetooth-enabled mobile device and a vehicle telematics system having two or more Bluetooth controllers, according to an exemplary embodiment of the present invention, may include one or more computer-readable storage devices and a plurality of program instructions stored on at least one of the one or more computer-readable storage devices. The plurality of program instructions may include program instructions to establish a Bluetooth communication channel between a mobile device and a first Bluetooth controller. The plurality of program instructions may further include program instructions to authenticate the mobile device by the first Bluetooth controller. The plurality of program instructions may further include program instructions to establish a secure connection between the first Bluetooth controller and a second Bluetooth controller, in response to successful authentication of the mobile device. The plurality of program instructions may further include program instructions to send authentication credentials of the authenticated mobile device from the first Bluetooth controller to the second Bluetooth controller. The plurality of program instructions may further include program instructions to process commands received from the mobile device via the Bluetooth communication channel.

In order to achieve the above objects, a wireless control module of a vehicle telematics system according to an exemplary embodiment of the present invention may include a first Bluetooth controller configured to communicate with a mobile device via a Bluetooth low energy protocol. The wireless control module may further include a second Bluetooth controller configured to communicate with the mobile device via a classic Bluetooth protocol. The second Bluetooth controller may be communicatively coupled to the first Bluetooth controller. The first Bluetooth controller may be further configured to establish a Bluetooth communication channel with the mobile device, authenticate the mobile device, establish a secure connection with the second Bluetooth controller, in response to successful authentication of the mobile device, and send authentication credentials of the authenticated mobile device to the second Bluetooth controller.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a wireless control module of a vehicle telematics system supporting two different Bluetooth protocols according to an embodiment of the present invention; and

FIG. 2 is a flowchart of operational steps of the wireless control module of FIG. 1 according to an illustrative embodiment of the present invention.

### DETAILED DESCRIPTION

The advantage and features of the embodiments disclosed herein and how to achieve the same will be explained through embodiments described in detail with the accompanying drawings However, the disclosure is not limited to embodiments described herein and may be embodied in other aspects. Rather, the embodiments are provided for explaining to those skilled in the art to which this disclosure pertains to readily embody the technical spirit of the present disclosure.

In the drawings, embodiments of the present disclosure are not limited to the shown specific aspects and are exaggerated in order to clarify. Although specific terms are used herein, it is only used for explaining the disclosed embodiments, and it is not used for limiting the meaning or the scope of the embodiments described in the claims.

The expression “and/or” herein is used as the meaning including at least one of components listed before and after the expression. Also, the expression “connected/coupled” is used as the meaning including being directly connected with another component or indirectly connected through another component. A singular form herein also includes a plural form unless it is specially referred in a phrase. Also, the components, steps, operations and elements referred as “comprise” or “comprising” used herein mean the presence or addition of at least one of other components, steps, operations and elements.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

As used herein, the phrase “vehicle telematics system” means an integrated telecommunications and information system with wireless communications capacity. These systems are sometimes referred to as in-vehicle infotainment systems, and are often integrated with entertainment systems and/or navigation systems. Vehicle telematics systems include, for example, but are not limited to, GM On-Star®, GM On-Star MyLink™, Chrysler UConnect®, Ford Sync®, Kia UVO®, Toyota Entune®, Hyundai BlueLink™ systems, and further includes other systems developed by these and other vehicle manufacturers and aftermarket component manufacturers.

Additionally, it is understood that the below methods for integrating BTC and BLE protocols may be executed by at least one controller. The term “controller” refers to a hardware device that includes a memory and a processor. The memory is configured to store program instructions, and the processor is configured to execute the program instructions to perform one or more processes which are described further below.

One aspect of the present invention relies on integration of Bluetooth protocols for setting up a wireless connection between one of the modules connected to a vehicle network and a remotely located mobile device. While the Bluetooth standard supports secure and reliable wireless communication between electronic devices, and while Bluetooth is widely supported by both vehicle manufacturers and consumer electronics device manufacturers, many consumers feel that the process of establishing Bluetooth communications between two devices, often known as pairing, is cumbersome and unintuitive. This is because security measures have been designed into the process of establishing Bluetooth communications between devices to prevent access by unknown or unauthorized devices. Further, currently vehicles' wireless communication systems typically include only one Bluetooth module supporting a particular Bluetooth protocol. The embodiments of the present invention solve this problem by integrating two entirely different types of wireless communication systems.

Various embodiment of the present invention are directed to making the pairing process with two different types of Bluetooth systems (e.g., internal and external vehicle Bluetooth environments) much simpler and much faster for the device user, while maintaining the security of Bluetooth connectivity. Hereinafter, it is understood that the vehicles referenced below include one Bluetooth communication module with two or more separate Bluetooth controllers for connecting with a terminal via two or more different types of Bluetooth protocols. Although this and other embodiments will be described with respect to Bluetooth protocols, the scope of the invention is not limited in this respect and may apply to any communication protocols utilized by different types of short range wireless communication systems.

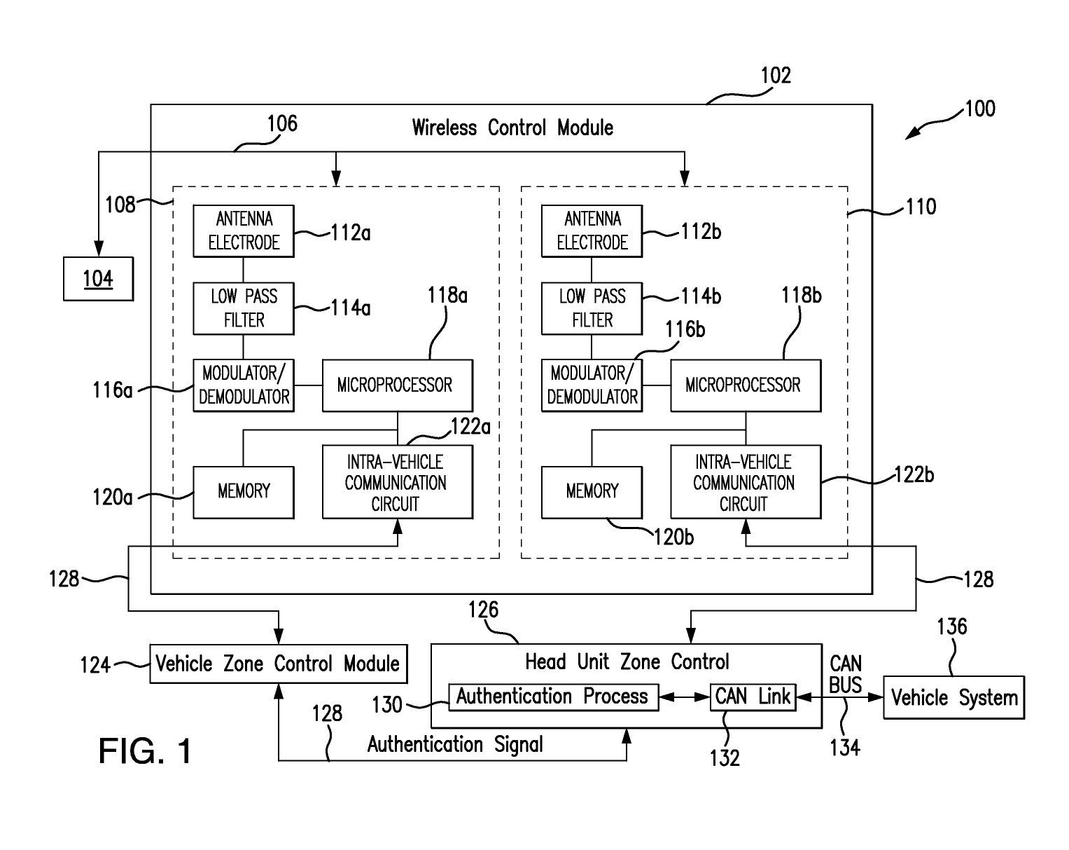

FIG. 1 is a block diagram illustrating an exemplary operating environment 100 for various embodiments. Operating environment 100 may include an in-vehicle computer system 136. A motor vehicle can be equipped with a head unit 126 having a user interface. The user interface can include various resource components such as a screen, speakers, a microphone, a touch screen and/or keypad, etc. The computer control system 136 of the car may be electrically coupled with a head unit 126 by a CAN Bus (Controller Area Network Bus) 134. Smart phones or other mobile devices (also called handsets) can download various application programs (“apps”) that operate on the mobile device. A user can utilize a user interface of the mobile device to control the application and/or utilize the application in some way (such as watching the visual display or listening to the audio output). Extending applications from the mobile device to the head unit has become a popular feature offered by various service providers and vehicle manufacturers. As a result, the user can take advantage of better user interface components offered by the head unit 126 (e.g., a larger screen and higher quality audio output). In some embodiments, a motor vehicle can be equipped with multiple head units 126 each of them being responsible for a different zone, for example.

Head unit 126 may further comprise a micro controller unit having built therein a control program, an authentication process 130 and a CAN data link 132 and physical signaling layers which are typically included in any controller that implements the CAN protocol. In one embodiment of the present invention head unit 126 may be electrically connected to a vehicle zone control module 124 and a wireless control module 102. Authentication process program 130 may be activated by the head unit 126 when the communicating party, including but not limited to a mobile device 104, is authenticated for access to the vehicle system's 136. In an embodiment, the vehicle zone control module(s) 124 may generally comprise the logic and/or functionality for controlling access to the vehicle's computer system 136 according to multi-zone access permissions, for example.

The head unit module(s) 126 and the vehicle zone control module(s) 124 may be implemented in software, hardware, firmware, or a combination thereof. In software or firmware embodiments, the logic may be written in any suitable computer language. In hardware embodiments, the modules may be implemented with any or a combination of the following, or other, technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The operating environment 100 may also include a wireless control module 102 and a two-way wireless communication link 106 for communication between the in-vehicle head unit 126 and/or the vehicle zone control module(s) 124 and the mobile device 104. At least in some embodiments, the communication link 106 may comprise a Bluetooth link. The Bluetooth enabled mobile device 104 has an operating system and can include various applications either integrated into the operating system or stored in a memory/storage and executed by a processor of the mobile device 104. Examples of the mobile device 104 include a cellular phone, personal device assistant (PDA), smartphone, pocket personal computer (PC), laptop computer, tablet computer, smart watch or other devices having a processor, communications capability and that are easily transportable. In a common form a mobile device application could be part of a larger suite of vehicle features and interactions.

The wireless control module 102 provided by embodiments of the present invention is a module that integrates the wireless communication function, with which a wireless communication can be performed between the mobile device 104 and the head unit 126. In one embodiment, the wireless control module 102 embodies software that can be installed to enable the in-vehicle head unit 112 to access both internal and external wireless communication systems, including but not limited to internal and external Bluetooth systems. This software is able to setup a new connection or open an existing connection and is able to direct communication across any application connection to provide a high quality experience for the user irrespective of the wireless protocol being used. For example, the wireless control module 102 may include two or more controllers 108, 110. Each controller 108, 110 is enabled to send and receive wireless packets in accordance with a respective wireless protocol. In the example shown in FIG. 1 and described herein, a first controller 108 is a Bluetooth Low Energy controller (BLEC) and thus implements the BLE wireless protocol. A second controller 110 is a Bluetooth classic controller (BCC) and, as such, preferably implements a classic Bluetooth protocol.

In one non-limiting embodiment, each controller 108, 110 may include an antenna 112, low pass filter 114, modulator/demodulator (modem) 116, microprocessor 118, memory 120 and an intra-vehicle communication circuit 122. Antennas 112 may include one or more conventional short-range omnidirectional Bluetooth antennas. Each controller 108, 110 may further include a low pass filter 114. The low pass filter 114 of each controller 108, 110 may be coupled to respective modem elements 116. Thus, the low pass filter 114 of each controller 108, 110 causes electrical energy to be diverted to modem elements 116 at lower frequencies. Low pass filters 116 may be any suitable type. In some embodiments, low pass filters 114 may include active circuitry, or passive components, such as capacitors. The type of components used may be based upon desired operating parameters of antenna 112. In general, low pass filters 114 generally filter signals above a low pass roll-off frequency.

As shown in FIG. 1, each controller 108, 110 may include respective modulators/demodulators 116 for performing modulation and demodulation functions. In other words, the output of the low-pass filter 114 is modulated by a modulator/demodulator 116 and sent out to a processor 118. The processor 118 is configured to execute program instructions to perform one or more processes which are described further below and the memory 120 is configured to store the program instructions. It is noted that each processor 118 preferably communicates with an intra-vehicle network 122 that couples in-vehicle devices with various monitoring and control modules.

According to a preferred embodiment of the present invention, the first controller 108 and the second controller 110 may communicate with each other through the CAN Bus 134 and/or through secure communication channels only. In one embodiment, the first controller 108 and the second controller 110 may communicate exclusively with each other via a discreet line of communication using a hardware security module (not shown in FIG. 1). In existing techniques for managing a Bluetooth connection between a vehicle and a mobile device, in order to communicate, the mobile devices are required to link with the vehicle's computer system by way of a Bluetooth pairing mechanism. However, various embodiments of the present invention contemplate that this Bluetooth pairing mechanism may be extended to more than one Bluetooth controller. In one embodiment, an authentication signal 128 may be utilized by the first 108 and second 110 controllers to share control of the Bluetooth connection/transfer process with the mobile device 104, as described below. In other words, contemplated embodiments of the present invention provide a means for rapidly accessing two or more Bluetooth controllers (i.e., BLEC and BCC) during the initial pairing process. As a result, a faster connection to the integrated Bluetooth wireless module 102 can be provided without compromising the security of Bluetooth connectivity.

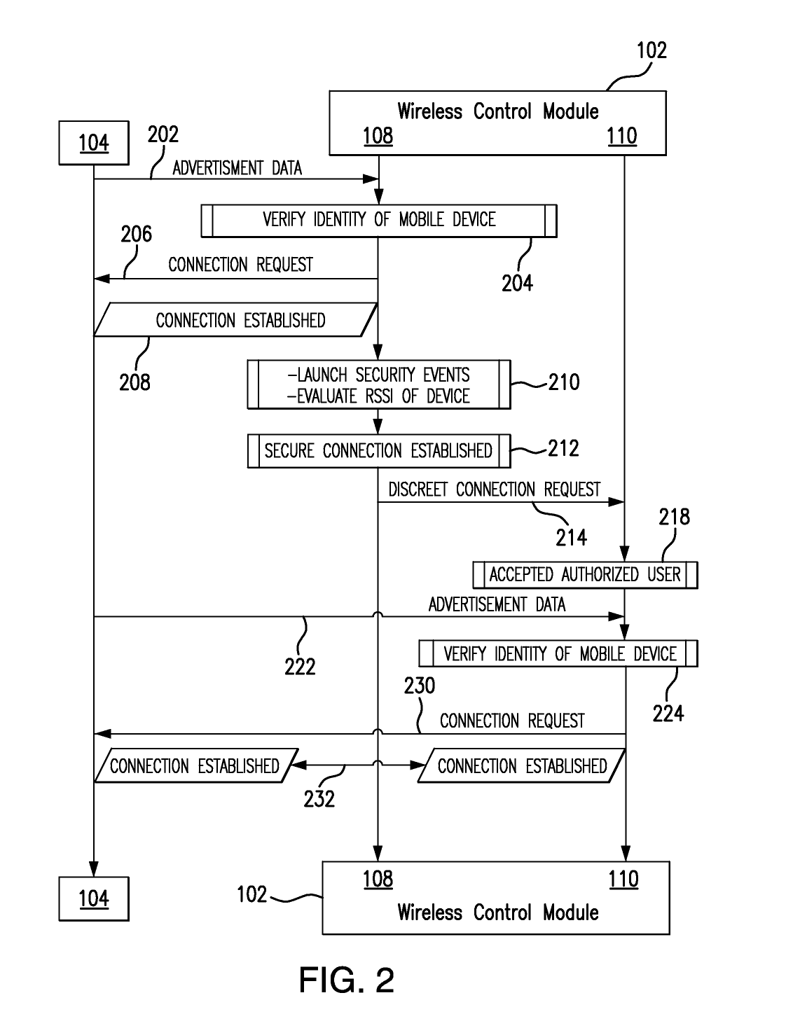

FIG. 2 is a flowchart of operational steps of the wireless control module of FIG. 1 according to an illustrative embodiment of the present invention. Before turning to description of FIG. 2, it is noted that the flow diagram shown therein is described, by way of example, with reference to components shown in FIG. 1, although these operational steps may be carried out in any system and are not limited to the scenario shown in the aforementioned figures. Additionally, the flow diagram in FIG. 2 shows example in which operational steps are carried out in a particular order, as indicated by the lines connecting the blocks, but the various steps shown in this diagram can be performed in any order, or in any combination or sub-combination. It should be appreciated that in some embodiments some of the steps described below may be combined into a single step. In some embodiments, one or more additional steps may be included.

According to an embodiment of the present invention, the wireless control module 102 may be implemented in software under the control of the one or more processors 118. The BLEC component 108 of the wireless control module 102 may comprise suitable logic, circuitry and/or code that may be operable to search for advertising BLE-enabled mobile devices 104 within range. The BLEC 108 may be configured to perform a passive scan or an active scan at step 202. In a passive scan, the BLEC 108 may be enabled to listen for advertising packets and may not transmit messages to mobile devices 104. In an active scan, the BLEC 108 may request the mobile device 104 to transmit additional information that may not be available in the received advertising packets. The current version of the BLE specification defines three advertising channels, which serve for device discovery and other broadcasting purposes. According to the BLE specification, packets sent in the advertising channels (index=37, 38 and 39) shall contain the device addresses, which are used to identify an advertising BLE enabled mobile device 104.

According to one embodiment of the present invention, at step 204, in response to detecting the presence of the mobile device 104, the BLEC 108 may verify identity of the mobile device 104. As noted above, packets sent in the advertising channels should include mobile device address information. In addition, the mobile device 104 may send an identity resolving key (IRK) associated with the mobile device 104. Thus, the verification performed at step 204 is based at least in part on the device address and/or IRK information contained in the received advertising packets. Further, the BLEC 108 may be enabled to send a connection request packet such as a Connect_REQ packet to the intended advertiser (i.e., mobile device 104) to request setup of a link layer connection, in response to verifying the identity of the mobile device 104. The BLEC 108 may be operable to send the Connect_REQ packet at step 206 in an advertising channel, in which the mobile device 104 is advertising. The Connect_REQ packet may comprise unique link layer connection parameters such as, for example, hopping frequency length (Hop_length), which may be used to calculate a data channel index.

In some embodiments, after the requested link layer connection is established at step 208, the BLEC 108 may become a master and the mobile device 104 may become a slave for the established link layer connection. As a master, the BLEC 108 may be capable of supporting multiple link layer connections at a time to various mobile devices 104. The BLEC 108 (master) may be operable to manage various aspects of data packet communication in a link layer connection with an associated slave such as the mobile device 104. For example, the BLEC 108 may be operable to determine an operation schedule in the link layer connection with the mobile device 104 (slave). The BLEC 108 may be operable to initiate a packet exchange sequence in the link layer connection with its own transmission. Link layer connections may be configured to run periodic connection events in data channels, such as Bluetooth communication channel 106 depicted in FIG. 1. Data packet transmissions may take place within connection events.

At 210, the BLEC 108 may launch various security events. It is noted that in BLE, the link layer provides encryption and authentication using Counter mode for encryption and Cipher block chaining for Message authentication (CCM) technique. CCM uses a temporal key (also called encryption key) to do the message encryption and authentication. It requires a unique nonce value for each data channel packet protected by a given temporal key. In an encrypted and authenticated connection, all of the data channel packets with a non-zero length payload are encrypted and authenticated. Authentication is performed by appending a message integrity check field to the payload. In addition, at step 210, the BLEC 108 may be operable to evaluate received signal strength indicator (RSSI) value of out-of-band radio signals for out-of-band characteristics. The BT EC 108 may be configured to determine timing and duration for each connection event based on the determined out-of-band blocking characteristics. The timing and duration may be determined to avoid transmission interferences (blockers) between in-band (BLE band) and out-of-band (non-BLE band) communication.

According to an embodiment of the present invention, in response to verifying the identity of the mobile device 104 (step 204) and in response to establishing a secure connection between the BLEC 108 and the mobile device 104 (step 212), at 214, the BLEC 108 may send a connection request to the BCC 110. This connection request may include authentication credentials of the authenticated mobile device 104. In one embodiment, the BLEC 108 may utilize a discreet authentication signal 128 to communicate with the BCC 110. According to an embodiment of the present invention, the BLEC 108 and BCC 110 may communicate with each other exclusively via an encrypted authentication signal 128.

At 218, the BCC 110 may process the received authentication credentials associated with the mobile device 104 and accept the mobile device as a device permitted to communicate with the BCC 110. In addition, the BCC 110 may be configured to perform an active scan at step 222. According to one embodiment of the present invention, at step 224, in response to detecting the presence of the mobile device 104, the BCC 110 may verify identity of the mobile device 104. As noted above, the advertisement data 222 sent in the advertising channels should include mobile device address information. Further, at 230, the BCC 110 may be enabled to send a connection request packet to the mobile device 104 to request setup of a link layer connection. As indicated above, the connection request 230 may include unique link layer connection parameters.

In view of the above description, after the requested link layer connection is established at step 232, the mobile device 104 may start communicating with both the BLEC 108 and BCC 110. Specifically, as a result of steps 202-230 performed by components of the wireless control module 102 (i.e., BLEC 108 and BCC 110) described above, the mobile device is now paired with two different types of Bluetooth systems and both the BT EC 108 and BCC 110 are now enabled to process commands received from the mobile device 104 via the two-way communication channel 106.

In the above description, the disclosed embodiments have been described through specific examples, but it may be well understood that various modifications can be made without departing from the scope of the present disclosure. Therefore, the scope of the present disclosure is not limited to the above described embodiments, and it should be defined by the appended claims and their equivalents. When taking the foregoing description into account, if the modifications and variations of the embodiments fall within the following claims and their equivalents, then it is construed that the present disclosure includes these modifications and variations.

What is claimed is:

1. A method of integrating Bluetooth protocols in establishing a connection between a Bluetooth-enabled mobile device and a vehicle telematics system having two or more Bluetooth controllers, the method comprising steps of:
establishing a Bluetooth communication channel between a mobile device and a first Bluetooth controller;
authenticating the mobile device by the first Bluetooth controller;
establishing a secure connection between the first Bluetooth controller and a second Bluetooth controller, in response to successful authentication of the mobile device;
sending authentication credentials of the authenticated mobile device from the first Bluetooth controller to the second Bluetooth controller; and
processing commands received from the mobile device via the Bluetooth communication channel by the first Bluetooth controller or the second Bluetooth controller.

2. The method according to claim 1, wherein the first Bluetooth controller comprises a Bluetooth low energy controller and wherein the second Bluetooth controller comprises a Bluetooth classic controller.

3. The method according to claim 1, wherein the Bluetooth communication channel comprises a two-way communication channel.

4. The method according to claim 1, wherein the secure connection provides encrypted communication between the first Bluetooth controller and the second Bluetooth controller.

5. The method according to claim 1, wherein establishing a Bluetooth communication channel between a mobile device and a first Bluetooth controller comprises receiving advertisement data from the mobile device.

6. The method according to claim 5, wherein the advertisement data includes mobile device's address information.

7. The method according to claim 4, wherein the encrypted communication comprises an encrypted authentication signal.

8. The method according to claim 1, wherein establishing a Bluetooth communication channel comprises determining a received signal strength indicator (RSSI) value based on a signal received from the mobile device.

9. A computer program product for integrating Bluetooth protocols in establishing a connection between a Bluetooth-enabled mobile device and a vehicle telematics system having two or more Bluetooth controllers, the computer program product comprising:
one or more computer-readable storage devices and a plurality of program instructions stored on at least one of the one or more computer-readable storage devices, the plurality of program instructions comprising: program instructions to establish a Bluetooth communication channel between a mobile device and a first Bluetooth controller;
program instructions to authenticate the mobile device by the first Bluetooth controller;
program instructions to establish a secure connection between the first Bluetooth controller and a second Bluetooth controller, in response to successful authentication of the mobile device;
program instructions to send authentication credentials of the authenticated mobile device from the first Bluetooth controller to the second Bluetooth controller; and
program instructions to process commands received from the mobile device via the Bluetooth communication channel.

10. The computer program product of claim 9, wherein the first Bluetooth controller comprises a Bluetooth low energy controller and wherein the second Bluetooth controller comprises a Bluetooth classic controller.

11. The computer program product of claim 9, wherein the Bluetooth communication channel comprises a two-way communication channel.

12. The computer program product of claim 9, wherein the secure connection provides encrypted communication between the first Bluetooth controller and the second Bluetooth controller.

13. The computer program product of claim 9, wherein the program instructions to establish a Bluetooth communication channel between a mobile device and a first Bluetooth controller comprise program instructions to receive advertisement data from the mobile device.

14. The computer program product of claim 13, wherein the advertisement data includes mobile device's address information.

15. The computer program product of claim 12, wherein the encrypted communication comprises an encrypted authentication signal.

16. The computer program product of claim 9, wherein the program instructions to establish a Bluetooth communication channel comprise program instructions to determine a received signal strength indicator (RSSI) value based on a signal received from the mobile device.

17. A wireless control module of a vehicle telematics system, comprising:
a first Bluetooth controller configured to communicate with a mobile device via a Bluetooth low energy protocol; and
a second Bluetooth controller configured to communicate with the mobile device via a classic Bluetooth protocol, the second Bluetooth controller communicatively coupled to the first Bluetooth controller via a secure connection,
wherein the first Bluetooth controller is further configured to establish a Bluetooth communication channel with the mobile device, authenticate the mobile device, establish a secure connection with the second Bluetooth controller, in response to successful authentication of the mobile device, and send authentication credentials of the authenticated mobile device to the second Bluetooth controller.

18. The wireless control module according to claim 17, wherein the first Bluetooth controller and the second Bluetooth controller are communicatively coupled to a head unit control module of a vehicle telematics system.

19. The wireless control module according to claim 17, wherein the secure connection provides encrypted communication between the first Bluetooth controller and the second Bluetooth controller.
